(19) United States
(12) Patent Application Publication
(10) Pub. No.: US 2014/0351720 A1
(43) Pub. Date: Nov. 27, 2014

(54) METHOD, USER TERMINAL AND SERVER FOR INFORMATION EXCHANGE IN COMMUNICATIONS

(71) Applicant: Alibaba Group Holding Limited, Grand Cayman (KY)

(72) Inventor: Hanghua Yin, Hangzhou (CN)

(73) Assignee: Alibaba Group Holding Limited, Grand Cayman (KY)

(21) Appl. No.: 14/285,150

(22) Filed: May 22, 2014

(30) Foreign Application Priority Data
May 22, 2013 (CN) 201310192855.4

(51) Int. Cl. H04L 12/58; H04N 7/15

(52) U.S. Cl. CPC H04L 51/04; H04N 7/157
USPC 715/758

(57) ABSTRACT

A method and an apparatus for exchanging interactive information between communicating parties. A sending user acts upon an avatar of the receiving user displayed on the sending user's terminal. The sending user's terminal monitors the acts, determines a playable message according to the detected interactive touch behavior, and plays the playable message on the sending user's terminal. The sending user's terminal sends related information to allow the receiving user's terminal to determine a second playable message in reaction to the touch behavior of the sending user. Both playable messages are related to the avatar and have a correspondence with the interactive touch behavior of the sending user in order to mimic a real life physical interaction between the two communicating parties.

### RELATED PATENT APPLICATIONS

This application claims foreign priority to Chinese Patent Application No. 201310192855.4 filed on May 22, 2014, entitled “METHOD, CLIENT TERMINAL AND SERVER FOR INFORMATION EXCHANGE IN COMMUNICATIONS”, Chinese Patent Application is hereby incorporated by reference in its entirety.

### TECHNICAL FIELD

The present application relates to interactive information exchange technologies, and more particularly to methods, user terminals and service used for interactive information exchanges.

### BACKGROUND

Improvement in communications technologies have enabled anytime anywhere communications among people using mobile devices. Existing communication methods based on mobile devices include text messaging, multimedia messaging, and phone calls. These methods have traditionally incurred quite high service fees for users. With the third-generation (3G) and higher mobile communication technologies and WiFi voice call technologies, along with the decreasing network data costs, and rapid expansion of smart mobile phones, many new methods of mobile communications have been introduced. One example is personal communication using mobile client applications, such as instant communication applications and gaming products that have built-in instant communication functions.

Unlike the traditional text messaging and telephone calls, communication methods based on mobile client applications are able to form virtual social networks which allow interactive communications within the social networks, including texting, voice messaging, sending photos and exchanging files, etc. The transmitted information can be received in real time as long as the recipient is connected to the Internet. Virtual social networking has made personal communications more convenient with lower costs.

In earlier mobile-app based instant communications, the information was primarily carried by text, although often accompanied by simple expressive pictures such as emoticons. New techniques have capabilities of visual calls, voice calls to make conversations more interactive, more virtual and audible. These newer methods may more accurately express the emotions of the users than the traditional text and pictures.

However, even the new methods remain wanting in expressing the real emotion and feeling that the users may have, and fall short of reproducing a real world in-person communication. There is still great room to improve in this regard.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure provides a method and an apparatus for exchanging interactive information between communicating parties. A sending user acts upon an avatar of a receiving user displayed on the sending user's terminal. The sending user's terminal monitors the acts, determines a first playable message according to the detected interactive touch behavior, and plays the playable message on the sending user's terminal. The sending user's terminal sends related information to allow the receiving user's terminal to determine a second playable message in reaction to the touch behavior of the sending user. Both playable messages are related to the avatar and have a correspondence with the interactive touch behavior of the sending user in order to mimic a real life physical interaction between the two communicating parties.

In one embodiment, the method determines the first playable message according to the interactive touch behavior by first determining an action code corresponding to the interactive touch behavior based on a matching relationship between interactive touch behaviors and action codes; and then determining the first playable message corresponding to the action code based on a matching relationship between the action codes and playable messages.

The method may further determine a relationship property of the sending user and the receiving user based on a prestored relationship property data of sending users and receiving users, and may further determine the first playable message according to the relationship property of the sending user and the receiving user. To determine the relationship property of the sending user and the receiving user, identity information of the sending user and the receiving user may be transmitted to a server to allow the server to determine the relationship property based on the prestored relationship property data.

Furthermore, by determining a relationship property of the sending user and the receiving user based on a prestored relationship property data of sending users and receiving users, the second playable message may also be determined according to the relationship property of the sending user and the receiving user.

To determine the first playable message according to the interactive touch behavior, the method may extract a behavioral characteristic from the detected interactive touch behavior; and then determine the first playable message based on a matching relationship between behavioral characteristics and playable messages. The extracted behavioral characteristic can be taken as the relating information of the interactive touch behavior and sent to a server to allow the server to determine the first playable message based on the matching relationship between the behavioral characteristics and the playable messages.

In one embodiment, in order to determine the first playable message corresponding to the interactive touch behavior, the method extracts a behavioral characteristic from the detected interactive touch behavior; determines an action code based on a matching relationship between behavioral characteristics and action codes; and then determines the first playable message based on a matching relationship between action codes and playable messages. The action code may be taken as the relating information of the interactive touch behavior and sent to the server to allow the server to determine the first playable message based on the matching relationship between the action codes and the playable messages.

In an embodiment, sending the relating information of the interactive touch behavior to the server or the receiving user's terminal comprises extracting a behavioral characteristic from the detected interactive touch behavior; and sending the extracted behavioral characteristic to the server or the receiving user's terminal to allow the server or the receiving user's terminal to determine the second playable message based on a matching relationship between behavioral characteristics and playable messages.

Alternatively, sending the relating information of the interactive touch behavior to the server or the receiving user's terminal may comprise extracting a behavioral characteristic from the detected interactive touch behavior; determining an action code based on a matching relationship between behavioral characteristics and action codes; and sending the action code to the server or the receiving user's terminal to allow the server or the receiving user's terminal to determine the second playable message based on a matching relationship between action codes and playable messages.

The detected interactive touch behavior of the sending user acted upon the avatar of the receiving user may include the sending user's touch behavior acted upon a designated area of a touch screen of the sending user's terminal, or the sending user's behavior of shaking the user terminal monitored using an acceleration sensor built in the terminal.

The method may further play a recorded voice message of the sending user along with the second playable message on the receiving user's terminal. The recorded voice message can be recorded at the sending user's terminal.

According to another aspect of the method for information exchange in communications, a server or a receiving user's terminal receives relating information of an interactive touch behavior of a sending user acted upon an avatar of the receiving user; the server or the receiving user's terminal determines a playable message according to the relating information of the interactive touch behavior. The playable message is related to the avatar and has a correspondence with the interactive touch behavior of the sending user. The playable message is then played on the receiving user's terminal.

In an embodiment, determining the playable message according to the interactive touch behavior comprises determining an action code corresponding to the interactive touch behavior based on a matching relationship between interactive touch behaviors and action codes, and determining the playable message corresponding to the action code based on a matching relationship between action codes and playable messages.

The method may further determine a relationship property of the sending user and the receiving user based on a prestored relationship property data of sending users and receiving users; and then determine playable message according to the relationship property of the sending user and the receiving user.

Another aspect of the disclosure is a computer-based apparatus for information exchange in communications. The apparatus includes a computer having a processor, computer-readable memory and storage medium, and I/O devices. The computer is programmed to perform functions including: presenting an avatar of a receiving user on a sending user's terminal; monitoring an interactive touch behavior of the sending user acted upon the avatar of the receiving user; determining a first playable message according to the interactive touch behavior; playing the first playable message on the sending user's terminal; and sending relating information of the interactive touch behavior to a server or the receiving user's terminal to allow the server or the receiving user's terminal to determine a second playable message according to the relating information of the interactive touch behavior. Both the first playable message and the second playable message are related to the avatar, have a correspondence with the interactive touch behavior, and can be played on the receiving user's terminal.

To determine the first playable message according to the interactive touch behavior, the computer may be programmed to further determine an action code corresponding to the interactive touch behavior based on a matching relationship between interactive touch behaviors and action codes, and to determine the first playable message corresponding to the action code based on a matching relationship between action codes and playable messages.

Other features of the present disclosure and advantages will be set forth in the following description, and in part will become apparent from the description, or understood by practice of the application. Purposes of this application and other advantages can be obtained by the written description, claims, and drawings of the structure particularly pointed out realized and attained.

### BRIEF DESCRIPTION OF THE FIGURES

FIG. 1 is a schematic flow of the first example of the method for exchanging information in interactive communications.

FIG. 2 is an example of a playable message incorporated in an avatar.

FIG. 3 is an example of indicators displayed with an avatar to instruct the user on how to act upon the avatar.

FIG. 4 is a schematic flow of the second example of the method for exchanging information in interactive communications.

FIG. 5 is a schematic flow of the third example of the method for exchanging information in interactive communications.

FIG. 6 is a schematic flow of the fourth example of the method for exchanging information in interactive communications.

FIG. 7 is a schematic flow of the fifth example of the method for exchanging information in interactive communications.

FIG. 8 is a schematic diagram of the function blocks of a sending user's terminal implementing the method for exchanging information in interactive communications.

FIG. 9 is a schematic diagram of the function blocks of a server implementing the method for exchanging information in interactive communications.

FIG. 10 is a schematic diagram of the function blocks of a receiving user's terminal implementing the method for exchanging information in interactive communications.

### DETAILED DESCRIPTION

In order to facilitate understanding of the above purpose, characteristic and advantages of the present disclosure, the present disclosure is described in further detail in conjunction with accompanying figures and example embodiments. In the description, the term “technique(s),” for instance, may refer to method, apparatus device, system, and/or computer-readable instructions as permitted by the context above and throughout the present disclosure.

In this description, the order in which a process is described is not intended to be construed as a limitation, and any number of the described process blocks may be combined in any order to implement the method, or an alternate method. An embodiment is described in sequential steps only for the convenience of illustration. Unless it would cause a conflict, the examples and embodiments described in the present disclosure, and the characteristics and features thereof, may be combined freely. Further, not every step described in the embodiments is required in order to practice the techniques of this disclosure.

In order to make instant communications more realistic and closer to real life face-to-face human interactions, this disclosure introduces a “touchable dimension” in addition to the visual and audio dimensions of the existing instant communications. In real life coming interactions, in addition to language, people may use body languages and physical interactions to communicate. Some of that is instinctive human behavior. A touchable dimension in instant communications may help reproduce such human experience.

### Example One

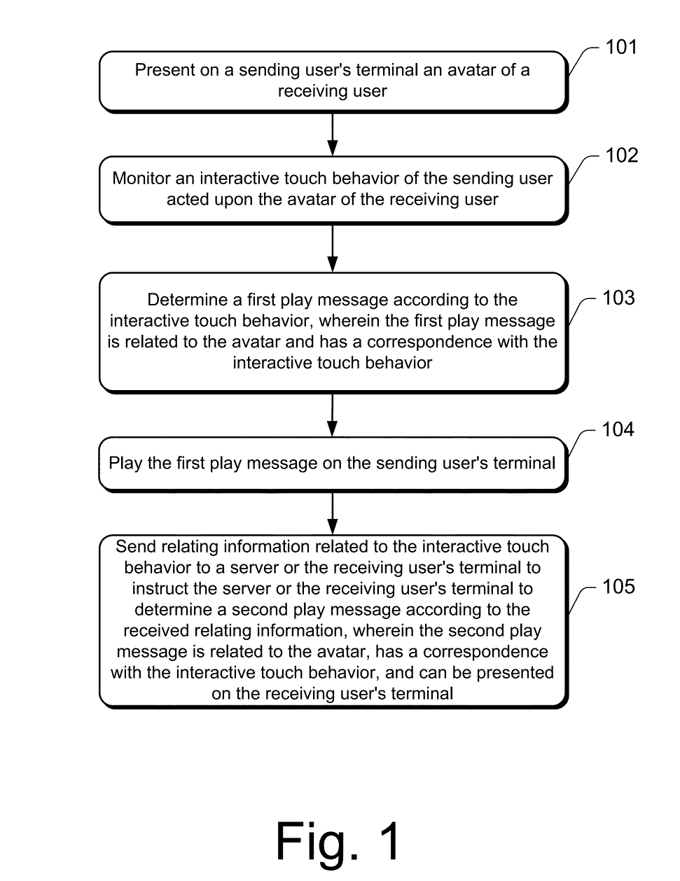

FIG. 1 is a schematic flow of the first example of the method for exchanging information in interactive communications.

At block 101, a sending user's terminal provides the sending user an avatar of a receiving user.

Suppose that a communication is taking place between a sending user and a receiving user, each user using a mobile terminal such as a smart phone. The sending user initiates a conversation or exchange of information. The sending user opens an address book on the sending user's terminal, and selects a user as the receiving user of the conversation. To do this, the sending user may click on an image or an icon of the receiving user and enter into a window for conversation. In the process, the receiving user and an associated avatar are determined.

For example, as part of the conversation, the sending user instructs the sending user's terminal through an entry in the user interface to send a message representing an interactive touch act (e.g., a touch on the receiving user's head, a kiss, etc.) Interactive touch acts are described in further detail hereinafter in this disclosure. The terminal determines the identity of the receiving user upon receiving the instruction, and presents an avatar of the receiving user to the sending user on the sending user's terminal. This way, as the sending user selects a receiving user of an interactive touch act, the sending user sees an avatar of the receiving user in the user interface displayed on the sending user's terminal.

The avatar of the receiving user may be prestored in the sending user's terminal or downloaded to the sending user's terminal through synchronization with a server which stores the user avatars. This way, the sending user's terminal can find the receiving users avatar locally and displays it to the sending user. Alternatively, if the sending user's terminal has no avatar of the receiving user, a downloading request or synchronization request may be first sent to a server to get an avatar of the receiving user. If an avatar is unavailable both locally and on the server, a default avatar may be presented to the sending user. In addition, the sending user's terminal may receive an avatar of the receiving user directly from the receiving user. The sending user's terminal may also create an avatar of the receiving user based on any other relevant information received from the receiving user (e.g., a photo, a voice, a video, an address).

In other words, for any user A, its avatar may be created at a server, created at a terminal of user A but stored at a server, sent directly from a terminal of user A to a terminal of user B, or created at a terminal of a sending user (or any other user). If user B needs to perform an interactive touch act on user A, user B may either obtain the avatar of user A from a server by downloading or synchronization, or receive the avatar from user A directly.

In order to make the information exchange process more realistic, an avatar of a user may be created based on a headshot photo of the user. If the avatar is created by the server, the server may require the user to upload a photo of the user. Preconfigured computer models may be used along with the photo to generate a combined virtual three-dimensional image which resembles the facial characteristics of the user. One way to do this is to use face recognition of image processing technology to identify the face or any part of the face (e.g., eyes, chin), parse line and color characteristics to obtain features such as hairstyle, skin color, facial shape, face size, glasses, and match these characteristic features with a user characteristic library to obtain an optimized avatar.

Based on a basic avatar, a series of expressive images may be created. For example, animations may be created to represent various emotions and reactions such as crying, tearing, an attentive ear with enlargement, etc. In the following discussions, animations are used as examples. These animations may each correspond to a certain type of interactive touch act, such that when a particular interactive touch act is performed, a respective animation (which is a form of a playable message) is played on the sending user's terminal and the receiving user's terminal. The respective animation represents a visually recognizable reaction to the interactive touch act.

If an avatar of a user has a series of images such as animations, another user may obtain the whole set of the series of images when receiving the avatar from a server or other users. The series may include the initial avatar which represents a status before any interactive touch act has been performed upon the avatar, and multiple animations corresponding to the various interactive touch acts.

The animation played on the sending user's terminal may be different from the animation played on the receiving user's terminal, each representing a proper reaction from the respective user's point of view. The animation played on the sending user's terminal is expressive of the sending user's action, while the animation played on the receiving user's terminal is expressive of the receiving uses reaction. For example, if user A sends a “smack” to user B, the animation played to user A may be a waving hand toward the head of user B's avatar to indicate a smack action, while the animation played to user B may be a tearing avatar suffering the smack. For this purpose, when user A obtains the avatar of user B from either a server or user B directly, the received avatar should include not only the initial avatar but also a series of animations representing various actions and reactions. Likewise, when user A uploads or synchronizes its own avatar to the server, the synchronization should include not only an initial avatar of user A but also a series of animations representing various actions and reactions.

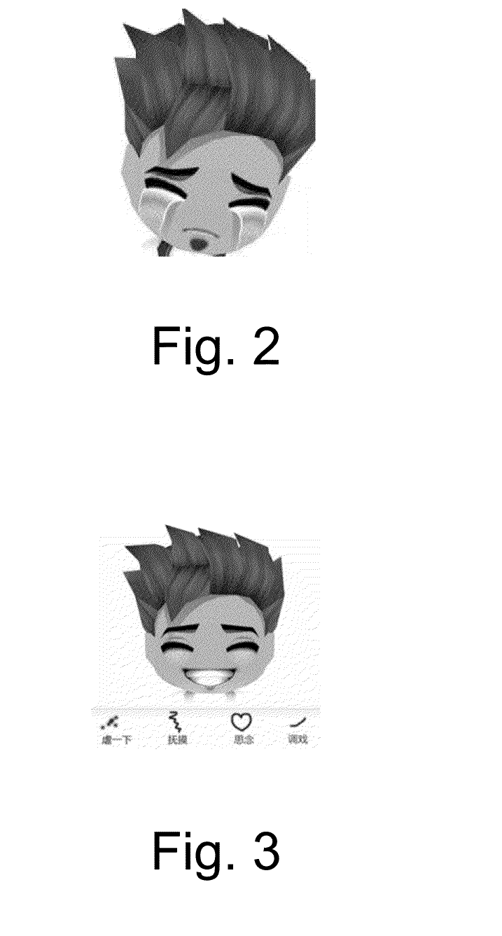

In addition to animations, the voices may be added as well. For example, when receiving a “smack”, the animation played may have a crying avatar of the receiving user, for example avatar 200 as illustrated in FIG. 2, accompanied by a sound of crying. The voice may be played alone without any animation if an animation is unavailable or needs not to be played for any reason. In this case, the sound alone is the playable message.

In the meaning of the present disclosure, a playable message refers to any combination of a sound, an image and/or an animation.

At block 102, an interactive touch behavior of the sending user acted upon the avatar of the receiving user is monitored.

Interactive touch behavior is manifested in specific acts, such as predefined actions representing inter-body contacts in real life. Examples of such actions include “a smack”, “a kiss”, “a touch”, etc.

From the sending user's point of view, an interactive touch act may be performed on the avatar of the receiving user displayed to the sending user. One way to implement an entry of such an act is to display an operation entry point for each type of act to allow the sending user to perform the act directly on the respective operation entry point. An example of an operation entry point is a clickable or touchable button on the user interface of the sending user's terminal. For example, buttons may be displayed representing, respectively, “a smack”, “a kiss”, or “a touch”. As the sending user clicks or touches a button, a corresponding touch act is registered.

User terminals generally have a touchscreen, an acceleration sensor and other sensors. Therefore, the sending user may perform a touch act by simply touching the touch screen, or by shaking the user terminal to change the relative position of the avatar on the touchscreen, etc.

Operations to trigger the touch acts may be predefined to correspond to a certain interactive touch act, so as the sending user makes a certain operation, the corresponding touch act is registered. The following is an example list of correspondence between operations and various touch acts:

a smack: multiple clicks on the head of the avatar;

a touch: a touch at the head of the avatar;

missing you: draw a heart over the avatar;

flirting: draw a line near the neck of the avatar;

the kiss: touch the lips of the avatar;

rocking: gently shake the user terminal;

shaking: strongly shake the user terminal;

a pinch: pinch or squeeze the face of the avatar;

talking to you: drag an ear of the avatar.

In other words, various operations on the user terminal can be defined to represent various interactive touch acts. Hints or instructions to the operations may be displayed along with the avatar. FIG. 3 is an example in which various icons 302 are displayed along with avatar 300 to indicate various operations corresponding to various touch acts such as “a smack”, “a touch”, “missing you”, and “flirting”.

To properly determine what playable message, and/or accompanying sound, is to be played, it is important to correctly identify the touch act intended by the sending user. In order to better identify the various touch acts when the sending user performs an operation, the various touch acts may be pre-codified using a unique code to represent each particular touch act, and a matching relationship that defines correspondence between each code to a particular set of user operation characteristics may be created and stored.

For example, hand gestures and touch operations performed may be characterized by several different characteristics, one that identifies the types of the operation (e.g., clicks or swipes), another that identifies the position of the operation (e.g., head area, or smaller areas such as nose, mouth or ear), and yet another that identifies the trace of the operation (e.g., whether the operation based a heart shape). With the definitions of the correspondence between various touch acts and various user operations, each operation may be reduced to a set of the unique operational characteristics which can uniquely represent the operation. This would result in a match list of correspondence between operational characteristics and the codes of the touch acts. For example, the touch act “a smack” corresponds to an act code 001, whose defined user operation should have the following characteristics: operation type=click; operation location=head. Therefore, the following correspondence relationship is created: “001—a click operation, at the head position”. During the communication process, if the detected touch behavior is reduced to the characteristics of “a click operation, at the head position”, it is then determined that the detected touch behavior corresponds to act code “001”, which corresponds to “a smack”. The interactive touch act is therefore identified by detecting the user operations.

Correspondingly, a procedure of recognizing an interactive touch act is to first extract operational characteristics from the detected user operations, then determine an action code corresponding to the detected user operations based on a matching relationship between various operational characteristics and action codes; and then determine the intended interactive touch act based on a matching relationship between action codes and various interactive touch acts.

In real applications, sometimes the user operations may not be performed properly, and as a result the proper operational characteristics may not be extracted, and the right action code may not be identified. In situations like this, a default action code may be used as the matching action code for the detected interactive touch behavior.

The above procedure described in block 102 may be performed on the sending user's terminal. That is, the matching relationship between the operational characteristics and action codes may be stored locally on the sending user's terminal. As the sending user's touch behavior is detected, the operational characteristics may be extracted locally, and used to identify the matching act code based on the stored matching relationship.

At block 103, a first playable message is determined according to the detected interactive touch behavior. The first playable message is related to the avatar and has a correspondence with the interactive touch behavior.

Upon detecting the interactive touch behavior, it is possible to determine a playable message that corresponds to the detected interactive touch behavior. The playable message is to be played to the sending user as a proper expression of the sending user's interactive touch behavior as indicated in the next block 104. On way to do this is to store a matching relationship between various interactive touch behaviors and various playable messages, and use the matching relationship to directly determine the first playable message that corresponds to the detected interactive touch behavior.

Although it is possible to determine the playable message directly from the detected interactive touch behavior, another way is to use a coding scheme as described herein in connection with block 102. For example, each interactive touch act may be assigned an act code, and each act code may be assigned to correspond to at least one playable message. The matching relationship between the act codes and playable message may be stored locally on the sending user's terminal. In addition, the matching relationship between the act codes and operational characteristics may also be stored locally. As an interactive touch operation is detected, operational characteristics are extracted from the detected interactive touch operation, and the corresponding act code is obtained based on the matching relationship between the operational characteristics and the act codes. Subsequently the first playable message is determined based on the matching relationship between the playable message and the action codes, and is played as needed.

In other words, for the sending user, in response to an interactive touch operation performed by the sending user, an animation and/or a voice is played locally. The animation and/or voice is related to the avatar of the receiving user, and the played message shows an expressive change of the avatar to reflect an expressive reaction of the receiving user to the interactive touch operation performed by the sending user.

For example, if user A performs a “talk to him” act on user B, an animation that shows “an enlarged and attentive ear” of user B is played on the terminal of user A, as if user A actually grabbed the ear of user B to make user B listen to him.

In the above-described example, the sending user's terminal parses the detected interactive touch behavior to determine which animation and/or voice needs to be played. This parsing function may also be performed by a server. In practice, the above-mentioned matching relationships may be stored in a server, so that the server may receive the operational characteristics and convert them into act codes and return the act codes to the sending user's terminal. In this configuration, the sending user's terminal only needs to store the matching relationship between the act codes and the playable message in order to determine which message (the first playable message) is to be played.

Alternatively, the server may further store the matching relationship between the act codes and playable message, so that the server may first convert the received operational characteristics into an act code, and further determine the corresponding first playable message, and then sends the first playable message to the sending user's terminal to be played. Instead of sending the first playable message itself, the server may alternatively send to the sending user's terminal a playable message code corresponding to the determined first playable message, and let the sending user's terminal play the first playable message which is locally stored or made available otherwise.

Alternatively, the server may just store the matching relationship between act codes and the playable messages. Upon detecting the interactive touch behavior of the sending user, the sending user's terminal extracts operational characteristics, determines the corresponding act code from the locally stored matching relationship between the act codes and the operational characteristics, and sends the determined act code to the server. The server then determines the first playable message code based on the matching relationship between the act codes and the playable message codes, and returns the code to the sending user's terminal, which plays the corresponding playable message locally as indicated in the next block 104.

At block 104, the first playable message is played on the sending user's terminal. The animation and/or voice may be played using any suitable technology.

At block 105, the sending user's terminal sends certain relating information of the interactive touch behavior to a server or the receiving user's terminal to allow the server or the receiving user's terminal to determine a second playable message according to the received relating information. Like the first playable message, the second playable message is also related to the avatar, has a correspondence with the interactive touch behavior, and can be played on the receiving user's terminal.

In an embodiment, the relating information is sent to the receiving user's terminal, which determines the second playable message according to the received relating information. The relating information may be sent to the receiving user's terminal directly using a point-to-point connection, or sent to an intermediary server which then passes the relating information to the receiving user's terminal. Alternatively, the relating information is sent to a server, which determines the second playable message according to the received relating information.

As discussed below, the above-described “relating information” can be in a variety of forms.

In a first exemplary form, the relating information comprises an act code as described above. In other words, the sending user's terminal may take the act code, which is determined to be corresponding to the detected interactive touch behavior, as the relating information and send it to the receiving user's terminal. The receiving user's terminal has previously obtained and stored the matching relationship between the act codes and playable message codes by, for example, synchronization with the server. Upon receiving the act code, the receiving user's terminal determines the code for the second playable message based on the matching relationship, and plays the second playable message corresponding to the determined code.

In a second exemplary form, the relating information comprises a code of the second playable message. That is, as the sending user's terminal parses the act codes, it obtains not only the code for the first playable message, but also the code for the second playable message, and sends the code for the second playable message to the receiving user's terminal. Alternatively, a server may be used as an intermediary the past relating information. In addition, if a server is used, the server may perform part of the parsing. For example, the sending user's terminal sends the act code to the server, which may determine the code of the second playable message based on the matching relationship between the act codes and the playable message codes, send the determined code as the “relating information” to the receiving user's terminal. The receiving user's terminal plays the second playable message corresponding to the received code.

It should be noted that like that with the first playable message, the receiving user's terminal may play a voice recording in addition to the animation of the avatar. The voice may be recorded at the sending user's terminal at the time when the sending user performs touching and shaking operations.

It is also noted that, the avatar of the same user may not be the same when displayed to different parties in the communication. For example, if in one communication user A is the sending user while user B is the receiving user, the avatar of user B displayed on user A's terminal may be different from the avatar of user B displayed on use of B's own terminal. But of course, the same avatar of user B may be used. There is no limitation in this regard.

As described above, in practicing of the disclosed embodiment, an avatar of the receiving user is displayed on the sending user's terminal to allow the sending user to perform interactive touch operations on the avatar. In response to the operations, an expressive picture (e.g. an animation) is displayed to the sending user, and another expressive picture (e.g., an animation) is displayed to the receiving user, to reproduce or mimic the kind of reaction the receiving user would have in real life if the sending user performs a natural touch action on the body of the receiving user. This provides a touchable dimension to the congregations, and improves user experience by increasing the level of reproduction of a real-life interaction.

Further details and examples are provided below using an actual example of communication.

### Example Two

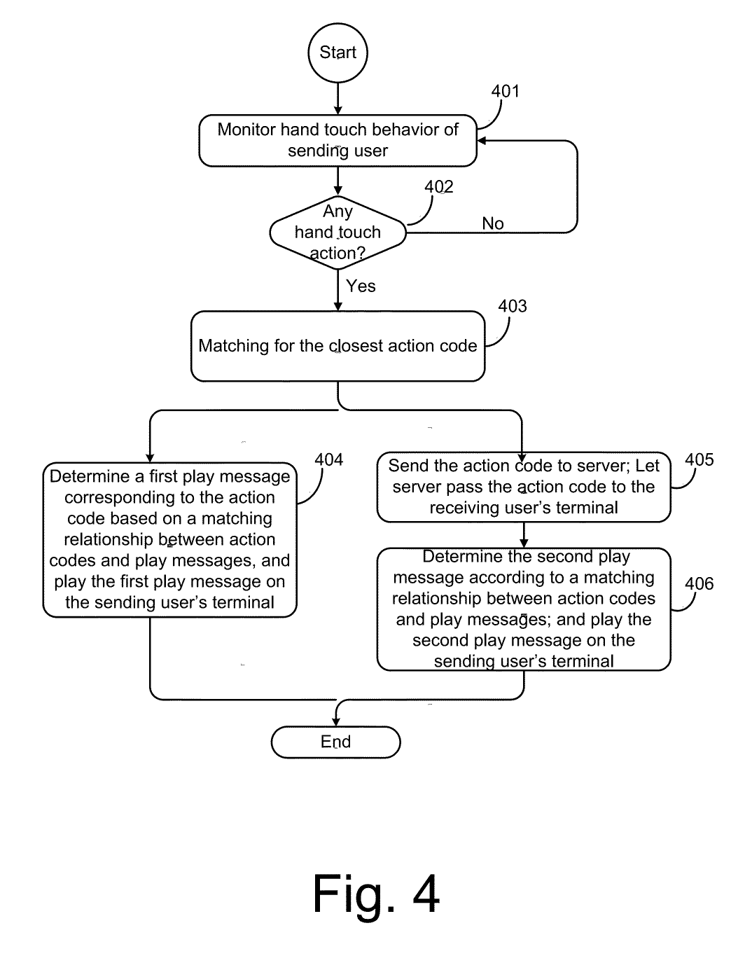

FIG. 4 is a schematic flow of the second example of the method for exchanging information in interactive communications.

At block 401, the sending user's interactive touch behavior is monitored and detected. A face of an avatar of the receiving user is treated as an identification area. For example, the ear, mouse, eyes, and hair may be touched.

Block 402 determines whether a hand touch operation of the sending user is detected. If yes, the procedure goes to block 403; if not, the procedure returns to block 401 to continue to monitor.

Block 403 matches the detected hand touch operation with the closest act code. At the same time, recording function may be initiated.

Block 404 determines a first playable message corresponding to the action code based on a matching relationship between action codes and playable messages, and plays the first playable message on the sending user's terminal.

Block 405 sends the determined action code to server; server passes the action code to the receiving user's terminal; alternatively, the action code may be sent to the receiving user's terminal directly.

The above blocks 404 and 405 may be combined into one step to be performed.

Block 406 determines the second playable message based on a matching relationship between action codes and playable messages; and plays the second playable message on the sending user's terminal. If a voice file is sent over from the server or the sending user's terminal, the voice may be played simultaneously.

Examples of various interactive touch behaviors may result in the following effects of playing messages in response to the touch behavior.

A smack: at the sending user's terminal, upon hitting the head of the receiving users avatar a few times, the sending user's terminal plays an animation of the head image of the avatar of the receiving user being smacked with the sound “what's the matter with you!”. When the relating information is sent to the receiving user's terminal, the receiving user's terminal gets the act code of being smacked, and plays a responsive animation, such as a crying avatar with a sound.

A touch: at the sending user's terminal, a touch of the receiving users avatar's head triggers a play of a touch act, and the receiving user's terminal plays an animation of being touched with accompanying sound.

Missing you: at the sending user's terminal, the sending user draws a heart over the avatar of the receiving user to trigger an act of missing the receiving user. The receiving user receives the relating information with a corresponding play of avatar animation. For example, receiving user may hear a few sneezes with the voice “somebody is thinking about me”, followed by a play of animation which shows the sending party's act of missing the receiving party, accompanied by the sending user's voice.

Flirting: at the sending user's terminal, draw a line near the neck of the receiving user's avatar to trigger an act of flirting, and the receiving party receives a corresponding animation expressing the act of flirting with voice.

A kiss: at the sending user's terminal, put a finger over the lips of the receiving party's avatar triggers an act of kissing. Upon receiving the relating information of the act, the receiving user's terminal plays a message showing lips wanting to be kissed. If the receiving user touches the lips using a finger, a return kiss is generated to trigger an animation of being kissed to be played.

Rocking: the sending user gently shakes the terminal triggers an act of rocking. An animation of the avatar of the receiving user being rocked is played on the receiving user's terminal.

Shaking: the sending user shake the terminal strongly to trigger an act of shaking the receiving user. An animation of the avatar of the receiving user being shaped displayed on the receiving user's terminal. For example, the avatar may be bumped to a wall (the edge of the screen) and accompanied by a sound of “ouch!”.

A pinch: an animation showing the face of the avatar of the receiving user being pinched may be played on both sides.

Talking to you: The sending user grabs the ear of the receiving user's avatar, which shows an enlarged and attentive ear. The sending user starts to speak and record a message. Upon receiving the relating information, an animation is played on the receiving user's terminal to show a speaking avatar of the sending user speaking the recorded message.

The animation reacting to a certain touch act by the sending user may be the same for different receiving users, and the animations of same receiving user triggered by the same touch act by different sending users may also be the same. However, the animations may be personalized according to the relationship between the sending user and the receiving user. For example, for the same receiving user B, the reaction may be stronger if the touch act was triggered by sending user A because the two have a closer relationship, but weaker if the touch act was triggered by sending user C because the two have a more distant relationship. Different animations reflecting different levels of reaction may be created for such purpose.

Not only the second playable message as a reaction by the receiving user to the touch act of the sending user personalized, but also the first playable message as an expression of the touch act by the sending user may also be personalized depending on the relationship of the two parties. That is, depending on the nature of the relationship between the sending user and the receiving user, as the sending user performs a certain touch act, the animation played to the same sending user to express the touch act may be different with regard to different receiving users; or the animation played two different sending users may be different with regard to the same receiving user. For example, if user A and user B have a closer relationship, while user C and user B have a more distant relationship, then if user A performs an act of “a smack” on user B, an animation 1 is played to user A, while an animation 2 is played to user B; but if user C performs an act of “a smack” on user B, an animation 3 is played to user C, while an animation 4 is played to user B. These animations can be designed to rapidly reflect the nature of the user relationships. In general, for example, animations 1 and 2 should reflect stronger emotions than animations 3 and 4.

For the above purpose, the server may create multiple playable messages for each interactive touch act. At the same time, users may be allowed to set the properties of their relationships to others, and such properties may be stored at the server. This way, the matching relationship between the act codes and the playable message codes may vary according to the property of the relationship between the two parties. As the server receives an act code, the server may determine a proper first playable message code and second playable message code based on the matching relationship personalized according to the relationship of the two parties.

In one embodiment, the sending user's terminal first extracts operational characteristics from the detected interactive touch behavior, and determines a corresponding act code based on the matching relationship between the operational characteristics and the act codes. The sending user's terminal then sends the act code along with the identities of the sending user and the receiving user to the server. Upon receiving the relating information, the server determines the first playable message code and the second playable message code based on the matching relationship between the act codes and playable message codes defined under the relation properties of the sending user and the receiving user. The relation properties may be predefined and stored at the server. The server returns the first playable message code to the sending user to allow a corresponding first playable message to be played on the sending user's terminal, and sends the second playable message code to the receiving user to allow a corresponding second playable message to be played on the receiving user's terminal.

In practice, however, the relation properties set by the users may be synchronized to the sending user's terminal to allow the sending user's terminal to determine the relationship property between the two users, and further determine the first playable message code and the second playable message code corresponding to the act code, based on the matching list personalized according to the relationship property of the two users. The sending user's terminal then plays the first playable message locally, and sends the second playable message code to the receiving user's terminal to allow the second playable message to be played on the receiving user's terminal.

The relationships between the users may be classified. For example, the contacts of a user may be divided into various groups and each group may have its own matching relationship to determine which playable message should be played for a certain touch act. In response to the same touch act, each group may have different playable messages. The playable messages may in general reflect the same kind of expression, but may have different degrees of emotion or level of reaction.

The relationship properties may be set by the users and stored at the server. As the server receives an act code from a sending user, the server first determines whether the sending user belongs to a certain group set by the receiving user, and further determines whether the receiving user has set a matching relationship between the act codes and the playable message codes to be different from that of other groups. If the answer to the above questions are yes, the server uses the particular matching relationship to determine the first and the second playable message codes corresponding to the act code, and sends the respective code to the sending user's terminal and the receiving user's terminal.

It is noted that a user's address book may have already been organized into various groups such as “classmates”, “friends”, “family members”, etc. These existing groups may be used as a basis to define different matching relationships of act codes and the playable message codes. Because the existing groups may not describe accurately how close a relationship is, different groups or subgroups may be defined to do this better.

In addition, a user may define a special matching relationship for another particular user. This can be used either instead of or in addition to groups. For this purpose, upon receiving the act code from a sending user, the server may first determine if the receiving user has defined a special matching relationship for the sending user, and determine the first and the second playable messages accordingly. If no special matching relationship is defined, the server may use the default matching relationship. Alternatively, the server may further determine if the sending user belongs to a certain group, and determine the first and the second playable messages accordingly.

The process is further illustrated using an example in FIG. 5.

Block 501 monitors the interactive touch behavior of user A performed upon user B.

Block 502 determines if the interactive touch behavior is detected. If yes, the process enters block 503. If not, the process returns to block 501 to continue to monitor.

Block 503 finds the closest matching act code corresponding to the interactive touch behavior detected.

Block 504 sends the closest matching act code to the server, which determines if user B (the receiving user) has predefined a special matching relationship between the act code and the corresponding playable message code. If yes, the process enters into block 509; if not, the process enters into block 505.

At block 505, the server determines if user B has predefined a customized matching relationship between the act code and the corresponding playable message code for a certain group. If yes, the process goes to block 506; if not, the process goes to block 507.

At block 506, the server determines if user A belongs to the group. If yes, the process goes to block 509; if not, the process goes to block 507.

At block 507, the server sends default playable message codes corresponding to the act code to the user A terminal and the user B terminal.

At block 508, the user A terminal and the user B terminal play the respective playable message corresponding to the playable message code received. The process ends.

At block 509, the server determines the playable message codes according to the predefined matching relationship for user A or for a group to which user A belongs, and sends the determined playable message codes corresponding to the action code to user A terminal and user B terminal.

At block 510, user A terminal and user B terminal play the respective playable message corresponding to the predefined playable message code.

In summary, using the above process, the reaction to touch acts can be personalized. For example, suppose user A performed a “flirting” act on user B. There may be several possible different relations user A has with user B. If user A and user B are having an intimate relationship, the playable messages corresponding to the act of “flirting” may reflect a suitable level of intimacy. But if user A and user B are just friends, the playable message played in response may reflect this type of a relationship. For example, the act of “flirting” may be recognized as really being a tease. If user A is disliked by user B, the playable message played the response may also reflect this type of a relationship, for example with an indifferent attitude.

Personalized reaction to interactive touch acts makes the user avatar appear more intelligent, more personal, more realistic, more accurate in expressing feelings, and more accurate in reflecting the type of relationships, all together making the communications closer to face-to-face interactions in real life.

### Example Two

The above description is from a point of view of the sending user's terminal. The following describes an example process from a point of view of a server.

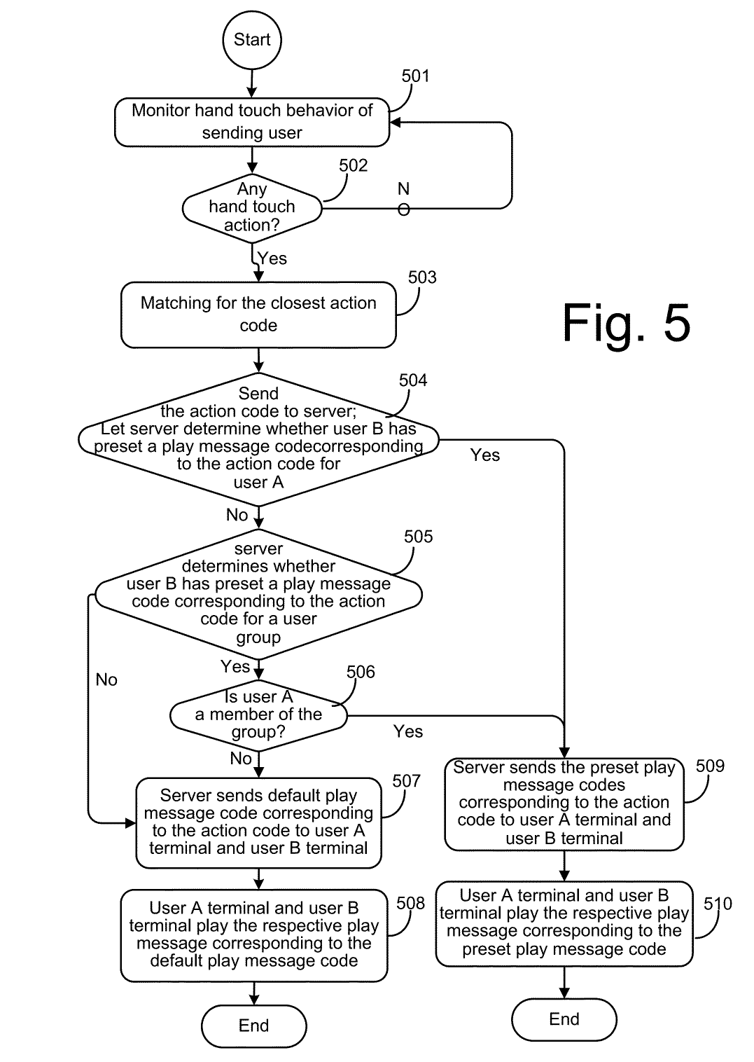

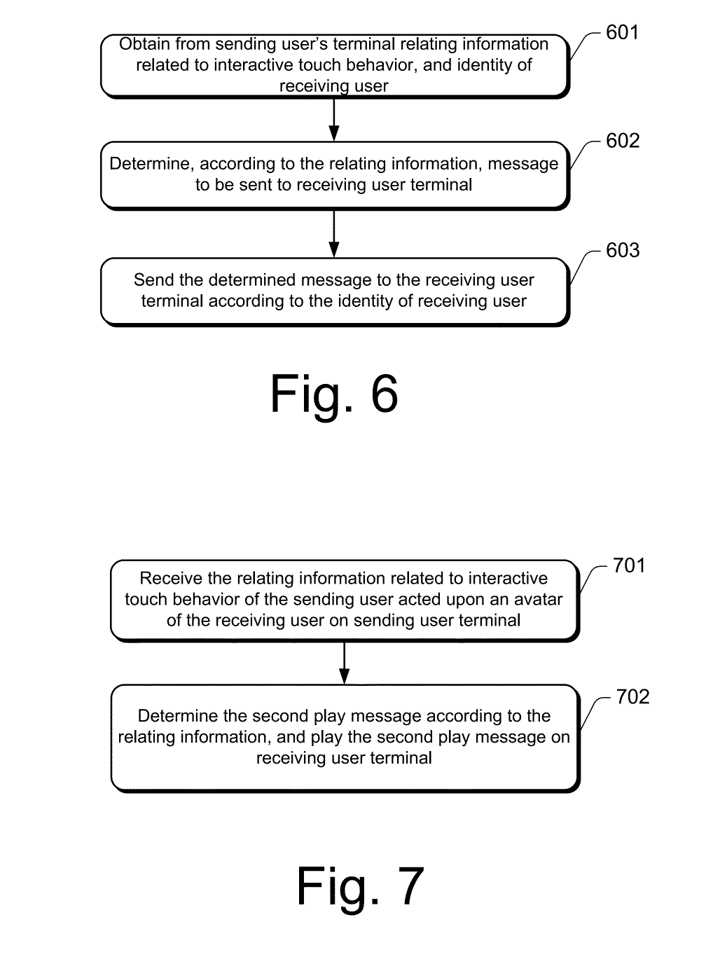

FIG. 6 shows a method for information exchange performed on a server.

At block 601, the server obtains from sending user's terminal relating information of interactive touch behavior of the sending user, and identity of receiving user.

At block 602, the server determines, according to the relating information, a message to be sent to receiving user's terminal.

At block 603, the server sends the determined message to the receiving user's terminal to allow the receiving user's terminal to determine the second playable message based on the received message. The second playable message is related to the avatar of the receiving user and corresponds to the interactive touch behavior.

In practice, the server analyzes the relating information obtained from the sending user's terminal to determine what message should be sent to the receiving user's terminal. Alternatively, the server may directly send the relating information to the receiving user's terminal to allow the receiving user's terminal to determine the second playable message based on the relating information.

In an embodiment, the server analyzes the relating information and determines the second playable message to be played at the receiving user's terminal, and sends the code of the second playable message to the receiving user's terminal.

The relating information may include operational characteristics extracted from the detected interactive touch behavior. In this case, the server may determine the second playable message using the prestored matching relationship between the operational characteristics and second playable messages. Alternatively, the relating information may include an act code corresponding to the detected interactive touch act. In this case, the server determines the second playable message using a prestored matching relationship between the act codes and the second playable messages.

In addition, depending upon the relationship between the sending user and the receiving user, different animations and/or voice recordings may be played in response to the same interactive touch act. For this purpose, the server stores relationship properties of users. The sending user's terminal sends user identity information to the server, in addition to the relating information of the interactive touch behavior. The identity information allows the server to customize the second playable message.

In practice, in addition to determining the second playable message for the receiving user's terminal, the server may also determine the first playable message for the sending user's terminal. To do this, the server obtains from the sending user's terminal the identity of the sending user, and determines the first playable message based on the relating information of the detected interactive touch behavior, and returns the code of the first playable message to the sending user's terminal based on the identity of the sending user.

The relating information of the detected interactive touch behavior may include an operational characteristic extracted from the detected interactive touch behavior to allow the server to determine the first playable message using a prestored matching relationship between the operational characteristics and the first playable messages. The relating information may also include an act code corresponding to the detected interactive touch behavior to allow the server to determine the first playable message using a prestored matching relationship between the act codes and the first playable messages.

The server may also determine (e.g., customize) the first playable message based on relationship properties between the sending user and the receiving user.

### Example Three

The disclosed method is further described below from a point of view of the receiving user's terminal. FIG. 7 shows a method for information exchange by the receiving user's terminal in communications.

At block 701, the receiving user's terminal receives the relating information of detected interactive touch behavior of the sending user acted upon an avatar of the receiving user on the sending user's terminal.

At block 702, the receiving user's terminal determines the second playable message according to the relating information, and plays the second playable message.

If sufficient relating information is provided to the receiving user's terminal, the user terminal is able to determine the second playable message locally. Similar to that described in Example Two in which the server determines the second playable message based on the relating information, in Example Three the relating information may include any of the following: operational characteristics of the detected interactive touch behavior, an act code corresponding to the detected interactive touch behavior, or a cold of the second playable message corresponding to the detected interactive touch behavior. The goal is to allow the receiving user's terminal to determine the second playable message accordingly.

It should be noted that in the above examples, the process is described from different angles. The examples may represent different aspects of the same process, or the present similar processes based on the same principle but with different action points in which the same functions are performed at a different location and by a different device among the sending user's terminal, the receiving user's terminal, and the server. Much of the description is based on the same principle and is not repeated herein.

The above-described techniques may be implemented with the help of one or more non-transitory computer-readable media containing computer-executable instructions. The non-transitory computer-executable instructions enable a computer processor to perform actions in accordance with the techniques described herein. It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

In connection to the method disclosed herein, the present disclosure also provides a computer-based apparatus for implementing the method described herein.

In the presence disclosure, a “module” in general refers to a functionality designed to perform a particular task or function. A module can be a piece of hardware, software, a plan or scheme, or a combination thereof, for effectuating a purpose associated with the particular task or function. In addition, delineation of separate modules does not necessarily suggest that physically separate devices are used. Instead, the delineation may be only functional, and the functions of several modules may be performed by a single combined device or component. When used in a computer-based system, regular computer components such as a processor, a storage and memory may be programmed to function as one or more modules to perform the various respective functions.

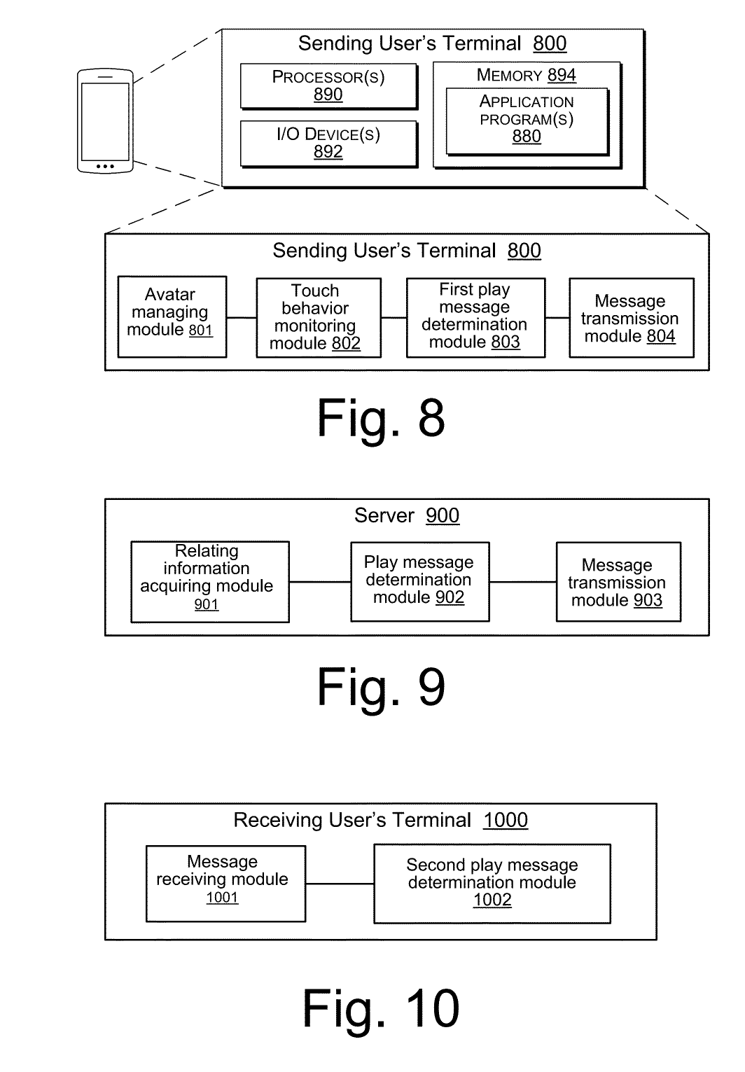

FIG. 8 is a schematic diagram of the function blocks of a sending user's terminal implementing the method for exchanging information in interactive communications.

Sending user's terminal 800 can be based on a typical smart phone hardware which has one or more processor(s) 890, I/O devices 892, and memory 894 which stores application program(s) 880. Sending user's terminal 800 is programmed to have the following functional modules.

Avatar managing module 801 is programmed to determine, select and/or present user avatars. For example, as a sending user initiates an information exchange, avatar managing module 801 may first determine the identity of the receiving user, and obtains or otherwise provides the avatar of the receiving user.

Touch behavior monitoring module 802 is programmed to monitor and detect interactive touch behavior of the sending user acting upon the avatar of the receiving user.

First playable message determination module 803 is programmed to determine the first playable message corresponding to the detected interactive touch behavior.

Message transmission module 804 is programmed to send relating information to the receiving user's terminal to allow the receiving user's terminal to determine and play the second playable message, based on the received relating information. The relating information is characteristically related to the detected interactive touch behavior, and can be in various forms as described herein.

Furthermore, the above modules may have programmed submodules to perform various functions as described herein in the context of the disclosed method. The details of these modules and submodules are not repeated.

FIG. 9 is a schematic diagram of the function blocks of a server implementing the method for exchanging information in interactive communications.

Server 900 can be based on a typical server hardware which has one or more processor(s), I/O devices, memory which stores application program(s). Server 900 is programmed to have the functional modules as described in the following.

Relating information acquiring module 901 is programmed to acquire the relating information from a sending user's terminal to allow server 900 to determine the message(s) to be sent to the receiving user's terminal. The relating information is characteristically related to the detected interactive touch behavior, and can be in various forms as described herein. The message(s) to be sent to the receiving user's terminal may also be various kinds (including but not limited to the second playable message), as described herein.

Playable message determination module 902 is programmed to determine the message(s) to be sent to the receiving user's terminal, based on the received relating information.

Message transmission module 903 is programmed to send the determined message(s) to the receiving user's terminal to allow the receiving user's terminal to determine the second playable message.

Furthermore, the above modules may have programmed submodules to perform various functions as described herein in the context of the disclosed method. The details of these modules and submodules are not repeated.

FIG. 10 is a schematic diagram of the function blocks of a receiving user's terminal implementing the method for exchanging information in interactive communications.

Receiving user's terminal 1000 can be based on a typical smart phone hardware which has one or more processor(s), I/O devices, and memory which stores application program(s). Receiving user's terminal 1000 is programmed to have the functional modules as described in the following.

Message receiving module 1001 is programmed to receive the relating information of the detected interactive touch behavior of the sending user acting on an avatar of the receiving user. The relating information is characteristically related to the detected interactive touch behavior, and can be in various forms as described herein. Depending on the configuration of the system, the relating information may be received from either a server, or the sending user's terminal, as described herein.

Second playable message determination module 1002 is programmed to determine and play the second playable message, based on the relating information received.

Furthermore, the above modules may have programmed submodules to perform various functions as described herein in the context of the disclosed method. The details of these modules and submodules are not repeated.

The above embodiments of the apparatus are closely related to the embodiments of the method described herein, and therefore the detailed description of the embodiments of the method is also applicable to the embodiments of the apparatus and is not repeated.

In summary, the present disclosure uses the avatar of a receiving user to generate animated media to reproduce or mimic real-life face-to-face touchable interactions between people. The sending user performs interactive touch acts on the avatar of the receiving user. The detected interactive touch acts are translated into animations to represent an expression of the sending user and a reaction of the receiving user. The animations may be played on either one or both of the sending user's terminal and the receiving user's terminal to create a “touchable” for of instant communications, thus increasing the level of reproduction of a real world face-to-face communication.

The technique described in the present disclosure may be implemented in a general computing equipment or environment or a specialized computing equipment or environment, including but not limited to personal computers, server computers, hand-held devices or portable devices, tablet devices, multiprocessor systems, microprocessor-based systems, set-top boxes, programmable consumer devices, network PCs, microcomputers and large-scale mainframe computers, or any distributed environment including one or more of the above examples.

The modules in particular may be implemented using computer program modules based on machine executable commands and codes. Generally, a computer program module may perform particular tasks or implement particular abstract data types of routines, programs, objects, components, data structures, and so on. Techniques described in the present disclosure can also be practiced in distributed computing environments, such a distributed computing environment, to perform the tasks by remote processing devices connected through a communication network. In a distributed computing environment, program modules may be located in either local or remote computer storage media including memory devices.

It is appreciated that the potential benefits and advantages discussed herein are not to be construed as a limitation or restriction to the scope of the appended claims.

Methods and apparatus of information verification have been described in the present disclosure in detail above. Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields.

What is claimed is:

1. A method for information exchange in communications, the method comprising:
presenting on a sending user's terminal an avatar of a receiving user;
monitoring an interactive touch behavior of the sending user acted upon the avatar of the receiving user;
determining a first playable message according to the interactive touch behavior, the first playable message being related to the avatar and having a correspondence with the interactive touch behavior;
playing the first playable message on the sending user's terminal; and
sending relating information of the interactive touch behavior to a server or the receiving user's terminal to allow the server or the receiving user's terminal to determine a second playable message according to the received information, wherein the second playable message is related to the avatar, has a correspondence with the interactive touch behavior, and can be played on the receiving user's terminal.

2. The method of claim 1, wherein the determining the first playable message according to the interactive touch behavior comprises:
determining an action code corresponding to the interactive touch behavior based on a matching relationship between interactive touch behaviors and action codes; and
determining the first playable message corresponding to the action code based on a matching relationship between action codes and playable messages.

3. The method of claim 1, further comprising:
determining a relationship property of the sending user and the receiving user based on a prestored relationship property data of sending users and receiving users; and
determining the first playable message according to the relationship property of the sending user and the receiving user.

4. The method of claim 3, wherein the determining the relationship property of the sending user and the receiving user comprises:
transmitting identity information of the sending user and identity information of the receiving user to the server to allow the server to determine the relationship property based on the prestored relationship property data.

5. The method of claim 1, further comprising:
determining a relationship property of the sending user and the receiving user based on a prestored relationship property data of sending users and receiving users; and
determining the second playable message according to the relationship property of the sending user and the receiving user.

6. The method of claim 5, wherein the determining the relationship property of the sending user and the receiving user comprises:
transmitting identity information of the sending user and identity information of the receiving user to the server or the receiving user's terminal to allow the server or the receiving user's terminal to determine the relationship property based on the prestored relationship property data.

7. The method of claim 1, wherein the determining the first playable message according to the interactive touch behavior comprises:
extracting a behavioral characteristic from the detected interactive touch behavior; and
determining the first playable message based on a matching relationship between behavioral characteristics and playable messages.

8. The method of claim 7, wherein the determining the first playable message based on the matching relationship between behavioral characteristics and playable messages comprises:
sending the extracted behavioral characteristic as the relating information of the interactive touch behavior to the server to allow the server to determine the first playable message based on the matching relationship between the behavioral characteristics and the playable messages.

9. The method of claim 1, wherein the determining the first playable message according to the interactive touch behavior comprises:
extracting a behavioral characteristic from the detected interactive touch behavior;
determining an action code based on a matching relationship between behavioral characteristics and action codes; and
determining the first playable message based on a matching relationship between action codes and playable messages.

10. The method of claim 9, wherein the determining the first playable message based on the matching relationship between action codes and playable messages comprises:
sending the action code as the relating information of the interactive touch behavior to the server to allow the server to determine the first playable message based on the matching relationship between the action codes and the playable messages.

11. The method of claim 1, wherein the sending the relating information of the interactive touch behavior to the server or the receiving user's terminal comprises:
extracting a behavioral characteristic from the detected interactive touch behavior; and
sending the extracted behavioral characteristic to the server or the receiving user's terminal to allow the server or the receiving user's terminal to determine the second playable message based on a matching relationship between behavioral characteristics and playable messages.

12. The method of claim 1, wherein the sending the relating information of the interactive touch behavior to the server or the receiving user's terminal comprises:
extracting a behavioral characteristic from the detected interactive touch behavior;
determining an action code based on a matching relationship between behavioral characteristics and action codes; and
sending the action code to the server or the receiving user's terminal to allow the server or the receiving user's terminal to determine the second playable message based on a matching relationship between action codes and playable messages.

13. The method of claim 1, wherein the monitoring the interactive touch behavior of the sending user acted upon the avatar of the receiving user comprises:
monitoring the sending user's touch behavior acted upon a designated area of a touch screen of the sending user's terminal.

14. The method of claim 1, wherein the monitoring the interactive touch behavior of the sending user acted upon the avatar of the receiving user comprises:
monitoring the sending user's behavior of shaking the sending user's terminal using an acceleration sensor built in the sending user's terminal.

15. The method of claim 1, further comprising:
playing a recorded voice message of the sending user along with the second playable message on the receiving user's terminal, the recorded voice message being recorded at the sending user's terminal.

16. A method for information exchange in communications, the method comprising:
receiving, at a server or a receiving user's terminal, relating information of an interactive touch behavior of a sending user acted upon an avatar of the receiving user;
determining, at the server or the receiving user's terminal, a playable message according to the relating information of the interactive touch behavior, the playable message being related to the avatar and having a correspondence with the interactive touch behavior of the sending user; and
playing the playable message on the receiving user's terminal.

17. The method of claim 16, wherein the determining the playable message according to the interactive touch behavior comprises:
determining an action code corresponding to the interactive touch behavior based on a matching relationship between interactive touch behaviors and action codes; and
determining the playable message corresponding to the action code based on a matching relationship between action codes and playable messages.

18. The method of claim 16, further comprising:
determining a relationship property of the sending user and the receiving user based on a prestored relationship property data of sending users and receiving users; and
determining the playable message according to the relationship property of the sending user and the receiving user.

19. A computer-based apparatus for information exchange in communications, the apparatus comprising:
a computer having a processor, memory, and I/O devices, the computer being programmed to perform functions including:
presenting on a sending user's terminal an avatar of a receiving user;
monitoring an interactive touch behavior of the sending user acted upon the avatar of the receiving user;
determining a first playable message according to the interactive touch behavior, the first playable message being related to the avatar and having a correspondence with the interactive touch behavior;
playing the first playable message on the sending user's terminal; and
sending relating information of the interactive touch behavior to a server or the receiving user's terminal to allow the server or the receiving user's terminal to determine a second playable message according to the relating information of the interactive touch behavior, wherein the second playable message is related to the avatar, has a correspondence with the interactive touch behavior and can be played on the receiving user's terminal.

20. The computer-based apparatus as recited in claim 19, wherein the determining the first playable message according to the interactive touch behavior comprises:
determining an action code corresponding to the interactive touch behavior based on a matching relationship between interactive touch behaviors and action codes; and
determining the first playable message corresponding to the action code based on a matching relationship between action codes and playable messages.
